(19) United States
(12) Patent Application Publication
(10) Pub. No.: US 2010/0161534 A1
(43) Pub. Date: Jun. 24, 2010

(54) PREDICTIVE GAUSSIAN PROCESS CLASSIFICATION WITH REDUCED COMPLEXITY

(75) Inventors: Sundararajan SELLAMANICKAM, Bangalore (IN); Sathiya Keerthi SELVARAJ, Cupertino, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/338,098

(22) Filed: Dec. 18, 2008

(51) Int. Cl. G06N 5/02

(52) U.S. Cl. 706/46

(57) ABSTRACT

A computer-implemented method of generating a model of a sparse GP classifier includes performing basis vector selection and adding a thus-selected basis vector to a basis vector set, including performing a margin-based method that accounts for predictive mean and variance associated with all the candidate basis vectors at that iteration. Hyperparameter optimization is performed. The basis vector selection step and hyperparameter optimization step are such that the steps are alternately performed until a specified termination criteria is met. The selected basis vectors and optimized hyperparameters are stored in at least one tangible computer readable medium organized in a manner to be usable as the model of the sparse GP classifier.

In one example, the basis vector selection includes use of an adaptive-sampling technique that accounts for probability characteristics associated with the candidate basis vectors. Performing the hyperparameter optimization and/or basis vector selection using the adaptive sampling technique may include considering a weighted negative-log predictive (NLP) loss measure for each example.

### BACKGROUND

Classification of web objects (such as images and web pages) is a task that arises in many online application domains of online service providers. Many of these applications are ideally provided with quick response time, such that fast classification can be very important. Use of a small classification model can contribute to a quick response time.

Classification of web pages is an important challenge. For example, classifying shopping related web pages into classes like product or non-product is important. Such classification is very useful for applications like information extraction and search. Similarly, classification of images in an image corpus (such as maintained by the online “flickr” service, provided by Yahoo Inc. of Sunnyvale, Calif.) into various classes is very useful.

With regard to shopping related web pages, product specific information is extracted in an information extraction system and more meaningful extractions can be achieved when only product pages are presented to such an information extraction system. On the other hand, providing product specific pages or class of images (like flowers or nature) related to search queries can enhance the relevance of search results.

In this context, building a nonlinear binary classifier model is an important task, when various types of numeric features represent a web page and a simple linear classifier may not be sufficient to get desired level of performance.

### SUMMARY

A computer-implemented method of generating a model of a sparse Gaussian Process (GP) classifier includes performing basis vector selection and adding a thus-selected basis vector to a basis vector set, including performing a margin-based method that accounts for predictive mean and variance associated with all the candidate basis vectors at that iteration. Hyperparameter optimization is performed. The basis vector selection step and hyperparameter optimization step are such that the steps are alternately performed until a specified termination criteria is met. The selected basis vectors and optimized hyperparameters are stored in at least one tangible computer readable medium organized in a manner to be usable as the model of the sparse GP classifier.

In one example, the basis vector selection includes use of an adaptive-sampling technique that accounts for probability characteristics associated with the candidate basis vectors. Performing the hyperparameter optimization and/or basis vector selection using the adaptive sampling technique may include considering a weighted negative-log predictive (NLP) loss measure for each example.

### BRIEF DESCRIPTION OF THE DRAWINGS

FIG. 1 is a block diagram illustrating a basic background regarding classifiers and learning.

FIG. 2 is a block diagram broadly illustrating how the model parameters, using in classifying, may be determined.

FIG. 3 is a block diagram illustrating a two-loop approach to a sparse GP classifier design approach using ADF approximation, and also illustrating steps in the two-loop approach for which intensity of computational and memory resources may be lessened.

FIG. 4 is a simplified diagram of a network environment in which specific embodiments of the present invention may be implemented.

### DETAILED DESCRIPTION

The inventors have realized that non-linear classifiers can be utilized to improve classification performance. However, the inventors have additionally realized that training of non-linear classifiers can be computation and/or memory intensive. In this patent application, GP classifiers are first discussed generally, and then some particular methods to reduce the computation and/or memory intensity of training such classifiers is described.

Gaussian process (GP) classifiers are the state of the art Bayesian methods for binary and multi-class classification problems. An important advantage of GPs over other non-Bayesian methods is that they provide confidence intervals associated with predictions for regression and posterior class probabilities for classification. While GPs provide state of the art performance, they suffer from a high computational cost of O(N³) for learning (sometimes called “training”) and memory cost of O(N²) from N samples. Further, predictive mean and variance computation on each sample cost O(N) and O(N²) respectively. As discussed in detail later, the inventors have realized that various approximation methods can be used to lower the computational cost for learning, yet provide a result that satisfactorily approximates a “full” training method.

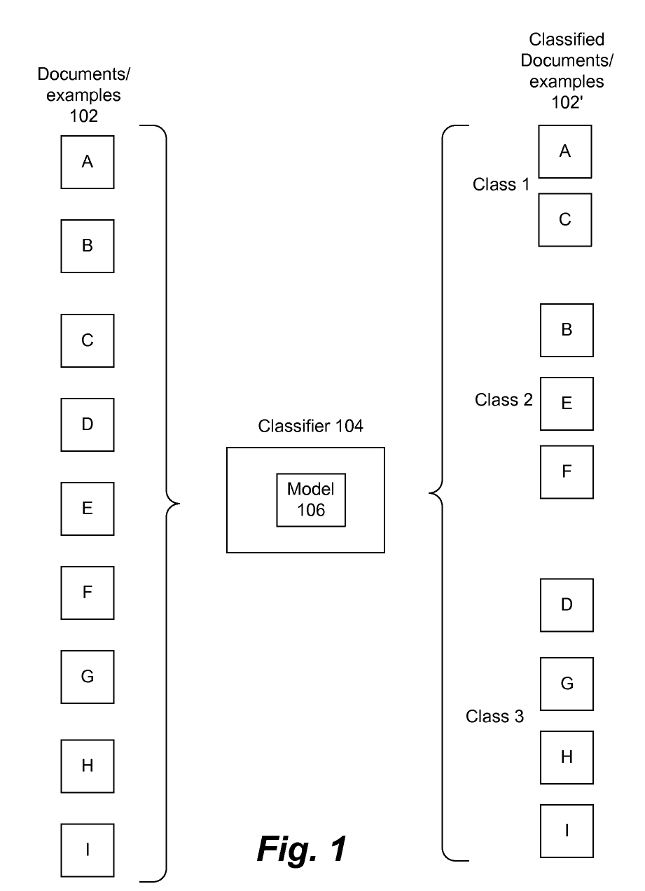

Before discussing the issues of computation costs for classification learning, we first provide some basic background regarding classifiers and learning. Referring to FIG. 1, along the left side, a plurality of web pages 102 A, B, C, . . . , G are represented. These are web pages (more generically, “examples”) to be classified. A classifier 104, operating according to a model 106, classifies the web pages 102 into classifications Class 1, Class 2 and Class 3. The classified web pages are indicated in FIG. 1 as documents/examples 102. For example, the model 106 may exist on one or more servers. In some examples, the classifier model is specific to a binary classification problem. However, a one-versus-rest type approach with multiple binary classifier models can address a multi-class classification problem. Then, the overall model will utilize multiple binary classifier sub-models.

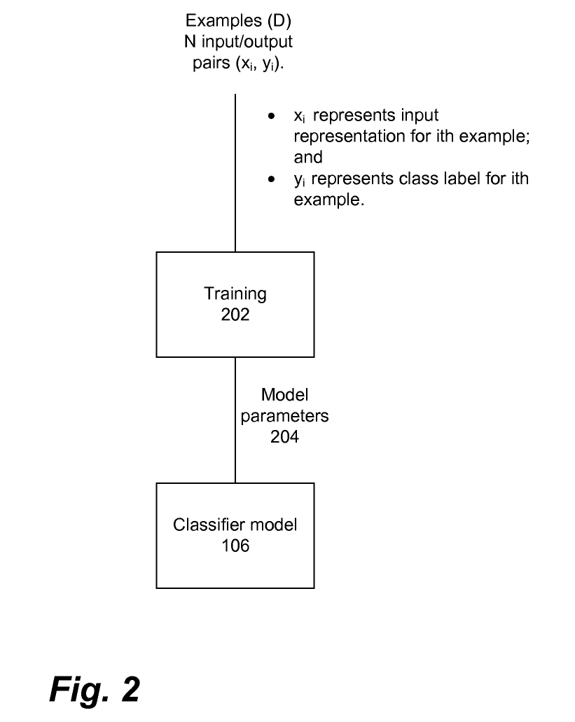

Referring to FIG. 2, this figure broadly illustrates how the model parameters, using in classifying, may be determined. Generally, examples ( [symbol] ) and known classifications may be provided to a training process 202, which determines the model parameters 204 and thus populates the classifier model 106. For example, the examples D provided to the training process 202 may include N input/output pairs (xᵢ, yᵢ), where xᵢ represents the input representation for the i-th example D, and yᵢ represents a class label for the i-th example D. The class label for training may be provided by a human or by some other means and, for the purposes of the training process 202, is generally considered to be a given.

Particular cases of the training process 202 are the focus of this patent application. In the description that follows, we first discuss the use of sparse approximate Gaussian Process (GP) classifiers for classification, and some general strategies for training sparse approximate GP classifiers. We then describe some strategies for reducing the cost of particular steps of the general strategies. Again, it is noted that the focus of this patent application is on particular cases of a training process, within the environment of GP classifiers.

In particular, there have been several approaches proposed to address this high computational cost of learning, by building sparse approximate GP models. Sparse approximate GP classifiers aim at performing all the operations using a representative data set, called the basis vector set or active set, from the input space. In this way, the computational and memory requirements are reduced to O(Ndₘₐₓ²) and O(Ndₘₐₓ), respectively, where N is the size of the training set and dₘₐₓ is the size of the representative set (dₘₐₓ<<N). Further, the computations of predictive mean and variance require O(dₘₐₓ), and O(dₘₐₓ²) effort respectively. Such parsimonious classifiers are preferable in many engineering applications because of lower computational complexity and ease of interpretation.

In this patent application, a focus is on describing an acceptable sparse solution of the binary classification problem using GPs. The active set is assumed to be a subset of the data for simplification of the optimization problem. Several approaches have been proposed in the literature to design sparse GP classifiers. These include Relevance Vector Machine (RVM) (Tipping, 2001), on-line GP learning (Csató and Opper, 2002; Csató, 2002) and Informative Vector Machine (IVM) (Lawrence, Seeger and Herbrich, 2003). Particularly related work is the IVM method which is inspired by the technique of ADF (Minka, 2001).

In general, sparse GP classifier design algorithm involves two steps—basis vector selection and hyperparameter optimization. The algorithms iterate over these steps alternately until a specified termination criterion is met. We further describe herein a validation based sparse GP classifier design method. This method uses negative log predictive (NLP) loss measure for basis vector selection and hyperparameter optimization. The model obtained from this method is sparse (with size dₘₐₓ<<N) and has good generalization capability. This method has computational complexity of O(κNdₘₐₓ²) where κ is usually of the order of tens. Though this method is computationally more expensive in the basis vector set selection step compared to, for example, the IVM method (having computational complexity O(Ndₘₐₓ²)), the classifier designed is observed to exhibit better generalization ability using fewer basis vectors.

Some advantages of this solution are now discussed. For example, while the IVM method is computationally efficient, the IVM method does not appear to exhibit good generalization performance, particularly on difficult or noisy datasets. Secondly, while the validation based method exhibits good generalization performance, it is still computationally very expensive. We note that the computational efficiency of the IVM method comes from selecting the basis vectors efficiently. In this patent application, we describe methods to select basis vectors efficiently (having same complexity as the IVM method) and still exhibit good generalization performance (closer to that of the validation based method).

For example, the described methods address the challenges as follows: (1) they work with reduced number of basis vectors enabling to address computational and memory issues in large scale problems, (2) they select the basis vector set effectively to build classifier models of reduced complexity with good generalization performance, and (3) they select the basis vector set efficiently, speeding up training.

Before describing the improved methods, we first discuss GP and Sparse GP Classification methods generally. In binary classification problems, a training set D is given composed of n input-output pairs (xᵢ, yᵢ) where xᵢεR^{d} (in many problems), yᵢε{+1,−1}, iεĨ and Ĩ={1, 2, . . . , n}. Here xᵢ represents input representation for ith example and target yᵢ represents a class label. A goal, then, is to compute the predictive distribution of the class label y* at test location x*.

In standard GPs for classification (Rasmussen & Williams, 2006), the true function values at xᵢ are represented as latent variables f(xᵢ) and they are modeled as random variables in a zero mean GP indexed by {xᵢ}. The prior distribution of {f (Xₙ)} is a zero mean multivariate joint Gaussian, denoted as p(f)= [symbol] (0,K), where f=[f(x₁), . . . , f(xₙ)]T, Xₙ=[x₁, . . . , xₙ] and K is the n×n covariance matrix whose (i, j)^{th} element is k(xᵢ, xⱼ) and is often denoted as K_{i,j}. One of the most commonly used covariance functions is the squared exponential covariance function given by:

$$cov ( f ( {x}_{i} ) , f ( {x}_{j} ) ) = k ( {x}_{i} , {x}_{j} ) = {w}_{0} exp ( - \frac{1}{2} {\sum }_{k = 1}^{d} \frac{{( {x}_{i , k} - {x}_{j , k} )}^{2}}{{w}_{k}} ) .$$

Here, w₀ represents signal variance and the wₖ's represent width parameters across different input dimensions. These parameters are also known as automatic relevance determination (ARD) hyperparameters. This covariance function is denoted the ARD Gaussian kernel function. Next, it is assumed that the probability over class labels as a function of x depends on the value of latent function value f(x). For the binary classification problem, given the value of f(x) the probability of class label is independent of all other quantities: p(y=+1|f(x), [symbol] )=p(y=+1|f(x)) where [symbol] is the dataset. The likelihood p(yᵢ|fᵢ) can be modeled in several forms such as a sigmoidal function or cumulative normal Φ(yᵢ|fᵢ) where

$$Φ ( z ) = {\int }_{- ∞}^{z} \frac{1}{\sqrt{2 π}} exp ( - \frac{{w}^{2}}{2} ) d w .$$

With an independence and identical distribution assumption, we have p(y|f)=Πᵢ₌₁^{N} p(yᵢ|fᵢ; γ). Here, γ represents hyperparameters that characterize the likelihood. The prior and likelihood along with the hyperparameters w==[w₀, w₁, . . . , w_{d}] and ƒ=[w,γ] characterize the GP model. With these modeling assumptions, the inference probability given θ can be written as:

p(y*|x*, [symbol] ,θ)=∫p(y*|f*,γ)p(f*| [symbol] ,x*,θ)df*. (1)

Here, the posterior predictive distribution of latent function f* is given by:

p(f*| [symbol] ,x*,θ)=∫p(f*|x*,f,θ)p(f| [symbol] ,θ)df (2)

where p(f| [symbol] , θ)∝Πᵢ₌₁^{N} p(yᵢ*|fᵢ, γ) p(f|X, θ). In sparse GP classifier design, the approximation of the posterior p(f| [symbol] , θ) plays an important role and is often one using an approach called Assumed Density Filtering (ADF) (Minka, 2001).

In this approach, for each data point (xᵢ,yᵢ) the non-Gaussian noise p(yᵢ|fᵢ) is approximated by an un-normalized Gaussian (also called the site function) with appropriately chosen parameters, mean mᵢ and variance pᵢ⁻¹, then the posterior distribution is approximated as

$$p ( f \vert , θ ) \approx q ( f \vert , θ ) ∝ ( 0 , K ) {\prod }_{i = 1}^{N} exp \{ - \frac{{p}_{i}}{2} \cdot {( {f}_{i} - {m}_{i} )}^{2} \} \\ and , thus p ( f \vert , θ ) \approx q ( f \vert , θ ) = ( \hat{f} , \hat{A} ) \qquad ( 3 )$$

where Â=(K⁻¹+Π)⁻¹ and \hat{f}=Â Πm and m=(m₁, . . . , m_{N})^{T} and Π=diag (p₁, . . . , p_{N}). Here, \hat{f} and Â denote the posterior mean and covariance respectively.

In general, GP classifier learning using the ADF approximation involves finding the site function parameters, mᵢ and pᵢ for every iε{1, 2, . . . , N} and the hyperparameters θ. Here, the site function parameters may be estimated using an algorithm known as Expectation propagation (EP) algorithm (Minka, 2001; Csato and Opper, 2002). This algorithm updates these parameters in an iterative fashion by visiting each example once in every sweep and usually several sweeps are utilized for convergence. Thus, all the site functions (corresponding to all N training examples) are used in determining the GP model. The hyperparameters are optimized either by maximizing marginal likelihood (Rasmussen and Williams, 2006) or negative logarithm of predictive probability (NLP) measure. Overall, the full model computational complexity turns out to be O(N³).

We now describe a general sparse GPC design. In sparse GP classifier models, the factorized form of q(f) is used to build an approximation to p(f| [symbol] , θ) in an incremental fashion. If u denotes the index set of training set examples which are included in the approximation, then we have an approximation qᵤ(f) of p(f| [symbol] , θ) as

$${q}_{u} ( f \vert , θ ) ∝ ( 0 , K ) {\prod }_{i {∈}^{o} u} exp \{ - \frac{{p}_{i}}{2} \cdot {( {f}_{i} - {m}_{i} )}^{2} \} \qquad ( 4 )$$

The set u is called the active or basis vector set (Lawrence et al, 2003). (Though u represents the index set of basis vectors, we also use it to denote the actual basis vector set Xᵤ.) The set u^{c}={1, 2, . . . , N}\u is referred to as the non-active vector set. For many classification problems, the size of the active set is restricted to the user specified parameter, dₘₐₓ, depending upon the classifier complexity and generalization performance requirements. It is noted that the site function parameters corresponding to the non-active vector set are zero. Thus a sparse GP model is defined by the basis vector set u, the associated site parameters and the hyperparameters θ. Now given the ADF Gaussian approximation qᵤ(f| [symbol] , θ), the approximate posterior predictive distribution can be computed from (Equation 2). Finally, for a binary classification problem and cumulative normal (probit noise), the predictive target distribution within Gaussian approximation may be given as,

$${q}_{u} ( {y}_{*} \vert {x}_{*)} = Φ ( \frac{{y}_{*} ( {\hat{f}}_{*} + b )}{\sqrt{1 + {σ}_{*}^{2}}} ) \qquad ( 5 )$$

Where \hat{f}* and σ*² are predictive mean and variance respectively for an unseen input x* (as given in the appendix) and b is a bias parameter (Seeger, 2005). Note that the dependencies of \hat{f}* and σ*² on u and other hyperparameters are not shown explicitly. A classification decision is made based on sgn(\hat{f}*+b).

In general, sparse GP classifier design method involves selection of basis vector set u from the training examples, its associated site function parameters and the hyperparameters. Optimization of each of them may be important in determining the generalization of final model. Here, we focus on the selection of basis vector set and leave the optimization of site function parameters and hyperparameters to standard methods described below. Before describing details of the proposed basis vector selection methods, we first describe some details about the generic sparse GP classifier design approach using ADF approximation.

In particular, we describe a two-loop approach to a sparse GP classifier design approach using ADF approximation. In the two-loop approach, the optimization alternates between the basis vector set selection and site parameter estimation loop (inner loop) and the hyperparameter adaptation loop (outer loop) until a suitable stopping condition is satisfied. The inner loop starts with an empty basis vector set with all the site parameters set to zero. A winner vector is chosen from the non-active vector set using a scoring function and is added to the current model with appropriate site function parameters. Here, the site function parameters are updated using moment matching of actual and approximate posterior distributions (Lawrence et al., 2003). The index of this winner is added to the basis vector set u. This procedure in the inner loop is repeated till dₘₐₓ basis vectors are added. Keeping the basis vector set u and the corresponding site function parameters (obtained in the inner loop) fixed, the hyperparameters are determined in the outer loop by optimizing a suitable measure.

There are two important steps involved in the above design and various methods differ in these steps. For example, the Informative Vector Machine (IVM) suggested by Lawrence et al (2003) uses entropy measure as the scoring function for basis vector selection and the hyperparameters are determined by maximizing the marginal likelihood. The validation based method uses NLP measure for both basis vector selection and hyperparameters optimization. We describe briefly the validation based method since it serves two purposes. Firstly, it can be used to illustrate complete sparse GP classifier (GPC) design; secondly, it can be useful to our basis vector selection method.

We first describe the validation based method. The validation based method makes use of the following NLP loss measure defined with respect to the basis vector set u and hyperparameters θ.

$$N L P ( u , θ ) = - \frac{1}{\vert {u}^{c} \vert} {\sum }_{{}^{j ∈ {u}^{c}}} log Φ ( \frac{{y}_{j} ( {\hat{f}}_{j} + b )}{\sqrt{1 + {A}_{jj}}} ) \qquad ( 6 )$$

where fⱼ and Aⱼⱼ denote the posterior mean and variance of the jth example in u^{c}. Note that θ includes the bias parameter b of the probit noise model; also, the site function parameters corresponding to the set u are implicit in defining the posterior mean and variance. This method follows the two loop approach.

Keeping the hyperparameters θ fixed, the basis vector set is constructed in an iterative manner starting from an empty set. This basis vector selection step is expensive and proceeds as follows. It picks a random subset J of examples of size κ=min(59, |u^{c}|) from the set u^{c} and computes NLP(ūⱼ, θ) where ūⱼ=u∪{j} for every j in J. Here, |u^{c}| denotes the cardinality of the set u^{c}. Then, a winner basis vector i is selected from J as:

$$i = {arg min}_{j ∈ J} N L P ( {\overline{u}}_{j} , θ ) \qquad ( 7 )$$

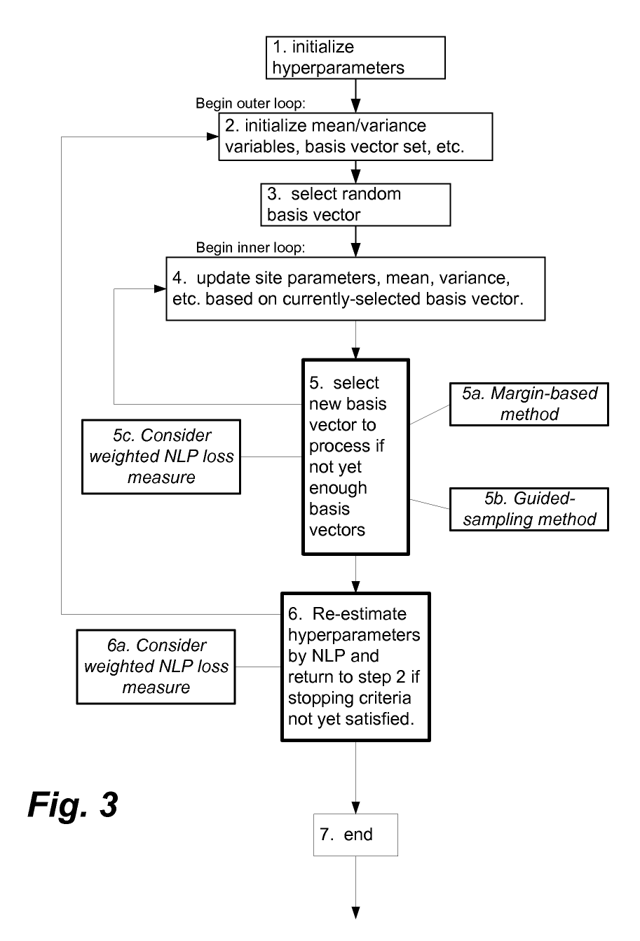

In this case, the computational effort needed to select a basis vector is O(κNdₘₐₓ). Once a basis vector is selected, its corresponding site parameters pᵢ and mᵢ are updated. Further, the posterior mean f and variance diag(A) are updated by including this newly selected basis vector in the model. (Supplemental details are provided in an appendix.) This procedure is repeated until dₘₐₓ basis vectors are added to the model. Therefore, the overall computational complexity is O(κNdₘₐₓ²). After this basis vector set selection and site parameters estimation, the hyperparameters θ are optimized over the NLP loss measure (Equation 6) using any standard non-linear optimization technique. Thus, this method makes use of (Equation 6) for both basis vector selection and hyperparameter optimization; and, it is assumed that dₘₐₓ<<N so that the predictive performance can be reliably estimated using (Equation 6). For ease of reference, the validation based method using two loop approach is summarized in the algorithm below. A flowchart illustrating this algorithm is provided in FIG. 3.

### Algorithm

1. Initialize the hyperparameters θ.

2. Initialize A:=K, u=ø, u^{c}={1, 2, . . . , N}, \hat{f}ᵢ=pᵢ=mᵢ=0 ∀iεu^{C}.

3. Select a random basis vector i from u^{c}.

4. Update the site parameters pᵢ and mᵢ, the posterior mean \hat{f} and variance diag(A) for the basis vector set ūⱼ, details of which are described later. Set u=u∪{i} and u^{c}=u^{c}\{i}.

5. If |u|<dₘₐₓ, create a working set J⊂u^{c}, find i according to (Equation 7, 8 or 12—Equations 8 and 12 are discussed later) and go to step 4.

6. Re-estimate the hyperparameters θ by minimizing weighted NLP in (Equation 6 or 11—Equation 11 is discussed later) by keeping u and the corresponding site parameters constant.

7. Terminate if the stopping criterion is satisfied. Otherwise, go to step 2.

We now discuss some proposed methods of basis vector selection in accordance with aspects of the invention. As mentioned earlier, the basis vector selection in the validation based method can be quite expensive (since K is usually of the order of tens). Compared to this method, the entropy based basis vector selection (in the IVM method) is efficient and costs O(Ndₘₐₓ) only. However, the entropy based selection does not exhibit good generalization performance, particularly on difficult or noisy datasets. Typically, the same generalization performance may be obtained using the validation based method with fewer number of basis vectors.

Here, we describe two methods of selecting basis vectors efficiently (like the entropy based basis vector selection) and yet which exhibit as good generalization as that of the expensive validation based method. The methods described below can be used as step 5 of the above algorithm directly (shown in bold in FIG. 3), for example. The two methods are shown in FIG. 3 as alternate methods, as step 5a and step 5b.

The first method we describe we call a “margin-based” method (step 5a in FIG. 3). This method does not require construction of a working set J in step 5 of the algorithm. In this method, the basis vector i from the non-active vector set u^{c} is selected as:

$$i = {argmin}_{{}^{j ∈ {u}^{c}}} \frac{\vert {\hat{f}}_{j} + b \vert}{\sqrt{1 + {A}_{jj}}} \qquad ( 8 )$$

It is noted that the predictive mean and variance of each example is updated after inclusion of every basis vector. Therefore, it is easy to select a basis vector set after every inclusion and it just costs O(N) to select a basis vector. Further, it has the advantage of considering all the examples in u^{c} compared to the validation based method (where only a subset of u^{c} is considered). It may be noted that a measure somewhat closer to (Equation 8) has been used in the context of a support vector machine (SVM) classifier (Bordes et al., 2005). However, the proposed measure is different in that it additionally has the denominator term. More specifically, (Equation 8) also takes the predictive variance term Aⱼⱼ into account, which is available only with probabilistic classifiers like GP classifiers. For example, preference is for the basis vector (example) with large variance over the one with lesser variance for the same numerator value. Due to this reason, the choice of basis vector set may in general be different.

A second method of selecting basis vectors efficiently is now described (step 5b in FIG. 3), which we call an adaptive sampling method. In the adaptive sampling method, we modify the random subset selection of basis vectors to construct the working set J in step 5 of the algorithm. This may be done as follows. First, we evaluate the predictive probability score p for all the examples in the set u^{c} as:

$${p}_{j} = Φ ( \frac{{y}_{j} ( {f}_{j} + b )}{\sqrt{1 + {A}_{jj}}} ) \qquad ( 9 )$$

Next, letting \tilde{p}ⱼ=1−pⱼ, a probability distribution may be defined over the set u^{c} as follows:

$${q}_{j} = \frac{{\tilde{p}}_{j}}{{\sum }_{{}^{j ∈ {u}^{c}}} {\tilde{p}}_{j}} \qquad ( 10 )$$

In its generic formulation, an adaptive subset of candidate basis vectors J can be sampled from this distribution instead of random sampling. Note that p_j changes after inclusion of a basis vector in each iteration. Therefore, the sampling distribution changes in each iteration and the sampling becomes adaptive. The working mechanism can be understood as follows: note that pⱼ takes a value closer to 1 if an example in u^{c} is correctly classified with very high confidence. On the other, pⱼ takes a value closer to 0 if an example is wrongly classified with very high confidence. Thus, qⱼ takes low or high probability value depending on whether the jth example in u^{c} is correctly or wrongly classified with very high confidence, respectively. Then, selecting a subset of candidate basis vectors according to this distribution is likely to select candidate basis vectors that correspond to wrongly classified examples or examples correctly classified with insufficient confidence. The appendix, below, provides additional commentary about how such a selection provides improved results.

Having chosen the candidate basis vector set J, the basis vector for inclusion can be selected using (Equation 7) as described earlier. In practice, the size of J is much smaller (in some cases, order(s) of magnitude) compared to the random sampling method to get the same generalization performance and a choice of κ=1 or 2 is adequate for many practical problems. Thus the basis vector selection computational complexity is the same as with the margin and entropy based methods.

We now discuss an alternate to (equation 7) to determine whether to select a particular basis vector for inclusion. (Equation 6) may be generalized to a weighted NLP loss measure. (This alternate method is shown in FIG. 3 as step 5c.) The weighted NLP loss measure may be given by:

$$W N L P ( u , θ ) = - \frac{1}{\vert {u}^{c} \vert} {\sum }_{{}^{j ∈ {u}^{c}}} {w}_{j} log Φ ( \frac{{y}_{j} ( {\hat{f}}_{j} + b )}{\sqrt{1 + {A}_{jj}}} ) \qquad ( 11 )$$

where wⱼ is the weight associated with the jth example in u^{c}. Thus, (equation 7) can be modified as:

$$i = {argmin}_{j ∈ J} W N L P ( {\overline{u}}_{j} , θ ) . \qquad ( 12 )$$

As an example, in the case of the adaptive sampling method, the weights can be directly set to the probability scores (q_j). Such a selection of basis vector aids in classifying difficult examples. Another use-case is to set the weights according to certain degree of importance that is desired to attach to each training example. In a binary classification problem, it may be desired to assign more weight to examples belonging to a positive class compared to a negative class. Such a requirement can be met using the weighted NLP loss measure methodology. Apart from using weighted NLP loss measure (equation 11) in the basis vector selection step, it can be used in the hyperparameters optimization step also (shown in FIG. 3 as step 6a). In general, the specific choice of weights may depend on a particular application.

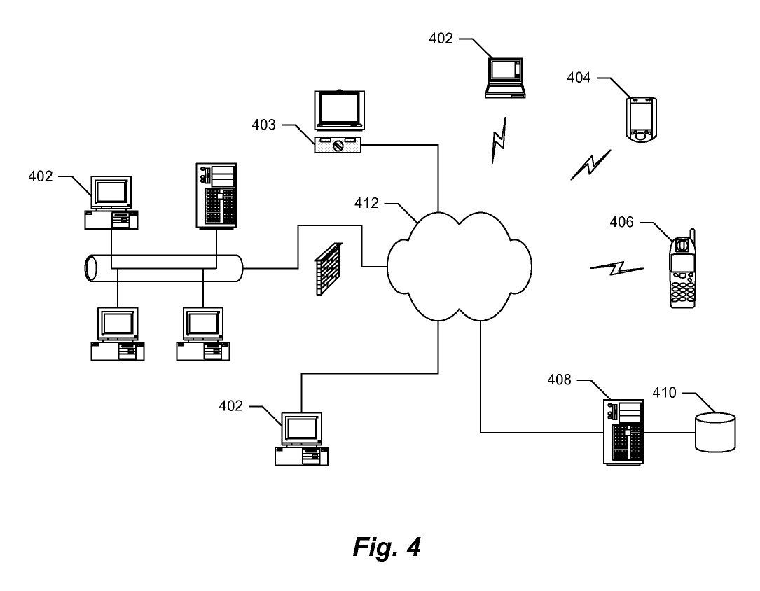

Embodiments of the present invention may be employed to facilitate implementation of binary classification systems in any of a wide variety of computing contexts. For example, as illustrated in FIG. 4, implementations are contemplated in which the binary classification system may operate within a diverse network environment via any type of computer (e.g., desktop, laptop, tablet, etc.) 402, media computing platforms 403 (e.g., cable and satellite set top boxes and digital video recorders), handheld computing devices (e.g., PDAs) 404, cell phones 406, or any other type of computing or communication platform.

According to various embodiments, applications may be executed locally, remotely or a combination of both. The remote aspect is illustrated in FIG. 4 by server 408 and data store 410 which, as will be understood, may correspond to multiple distributed devices and data stores.

The various aspects of the invention may be practiced in a wide variety of environments, including network environment (represented, for example, by network 412) including, for example, TCP/IP-based networks, telecommunications networks, wireless networks, etc. In addition, the computer program instructions with which embodiments of the invention are implemented may be stored in any type of tangible computer-readable media, and may be executed according to a variety of computing models including, for example, on a stand-alone computing device, or according to a distributed computing model in which various of the functionalities described herein may be effected or employed at different locations.

We have described the use of non-linear classifiers to improve classification performance of binary classifiers that operate to determine whether an example (document) is either within or outside a particular class. We have further described methods of training non-linear classifiers to reduce intensity of computation and/or memory usage. By reducing the intensity of computation and/or memory usage, the classifiers in accordance with aspects of the invention may be better suited for operational environments such as classifying examples such as web pages, images, etc.

The following references are referred to in the description:
Bordes, A., Seyda Ertekin, Jason Weston and Leon Bottou. (2005). Fast Kernel Classifiers with Online and Active Learning. Journal of Machine Learning Research 6, 1579-1619.
Csato, L., and Opper, M. (2002). Sparse on-line Gaussian processes. Neural Computation, 14(3), 641-668.
Lawrence, N., Seeger, M., and Herbrich, R. (2003). Fast sparse Gaussian process methods: The informative vector machine. In S. Becker, S. Thrun, and K. Obermayer (Eds), Advances in Neural Information Processing Systems 15, 609-616, Cambridge, Mass.: The MIT Press.
Minka, T. P. (2001). A family of algorithms for approximate Bayesian inference. Doctoral dissertation, Massachusetts Institute of Technology.
Rasmussen, C. E. and Williams, C. K. I. (2006). Gaussian Processes for Machine Learning. MIT Press.
Seeger, M. (2005). Bayesian Gaussian process models: PAC-Bayesian generalization error-bounds and sparse approximations. Doctoral dissertation, University of Edinburgh, Edinburgh, Scotland.
Tipping, M. E. (2001). Sparse Bayesian learning and the Relevant Vector Machine. Journal of Machine Learning Research, 1, 211-244.

### APPENDIX

In this appendix we describe an example of step 4 processing of the FIG. 3 algorithm in greater detail. Suppose that an example index j is added to the current BV set u. Let uⱼ=u∪{j}. Incremental calculations are carried out to update the site function parameters and update \hat{f} and A corresponding to uⱼ. This is achieved by maintaining two matrices L and M where L is the lower-triangular Cholesky factor of B=I+Π_{u,u}^{1/2}K_{u,u}Π_{u,u}^{1/2} and M=L⁻¹Π_{u,u}K_{u,.}; note that A=K−M^{T}M. Note that K_{u.,} denote a row matrix corresponding to the set u in the matrix K and K_{u,u} denote a sub-matrix at the row-column intersection of the set u in K. With

$${z}_{i} = \frac{{y}_{i} ( {f}_{i} + b )}{\sqrt{1 + {A}_{ii}}} , {α}_{i} = \frac{{y}_{i} N ( {z}_{i} ; 0 , 1 )}{Φ ( {z}_{i} )} \sqrt{\frac{1}{1 + {A}_{ii}}} , {v}_{i} = {α}_{i} ( {α}_{i} + \frac{( {\hat{f}}_{i} + b )}{1 + {A}_{ii}} )$$

the site function parameters are updated as:

$${p}_{i} = \frac{{v}_{i}}{1 - {A}_{ii} {v}_{i}} , {m}_{i} = {f}_{i} + \frac{{α}_{i}}{{v}_{i}} \qquad ( 13 )$$

where N(•;0,1) is normal distribution with zero mean and unit variance, and with

$$I = \sqrt{{p}_{i}} {M}_{\cdot , i} , l = \sqrt{1 + {p}_{i} {K}_{i , i} - {I}^{T} I} , μ = {l}^{- 1} ( \sqrt{{p}_{i}} {K}_{\cdot , i} - {M}^{T} I ) , \\ L := ( \begin{matrix}L & 0 \\ {I}^{T} & l\end{matrix} ) , M := ( \begin{matrix}M \\ {μ}^{T}\end{matrix} )$$

the posterior variance and mean are updated as:

diag(A):=diag(A)−μ²,\hat{f}:=\hat{f}+αᵢlpᵢ^{-1/2}μ. (14)

In (14), μ² denotes squaring of each element in μ. These update calculations have O(Ndₘₐₓ) computational complexity. Thus, ignoring the cost of basis vector selection in each iteration (for the time being) the overall computational cost is O(Ndₘₐₓ²).
Predictive mean and variance for a test input x_{*}: With the probit noise model, the predictive mean and variance for a test input x_{*} are given by:

$${\hat{f}}_{*} = {k}_{* , u} {\prod }_{u}^{\frac{1}{2}} {B}^{- 1} {\prod }_{u}^{\frac{1}{2}} {m}_{u}$$

$$and . {σ}_{*}^{2} = k ( {x}_{*} , {x}_{*} ) - {k}_{* , u} {\prod }_{u}^{\frac{1}{2}} {B}^{- 1} {\prod }_{u}^{\frac{1}{2}} {k}_{u , *}$$

Working principle of adaptive sampling technique: To understand why adaptive sampling would be useful, we can see that if qᵢ (equation 10) is 0 (1) for a given example i, then its probability of selection will be relatively small(high). Next, the sign of αᵢ in (equation 14) gets adjusted in such a way that \hat{f} moves in the right direction for a given μ through K_{.,i}. This right movement is expected to happen for all examples having same class label that are close enough to the ith example. Since the variance diag(A) is non-increasing, we expect the NLP score (equation 7) to improve particularly for the examples with wrong predictions or low confidence. Intuitively such improvement with adaptive sampling is expected to be higher and this helps in getting better generalization performance for fixed κ compared to random sampling. Alternately, κ can be reduced to get same generalization performance.

1. A computer-implemented method of generating a model of a sparse GP classifier, the classifier usable to classify examples as being either in or not in a particular category, the method comprising:
performing basis vector selection and adding a thus-selected basis vector to a basis vector set, including performing a margin-based method that accounts for predictive mean and variance associated with all the candidate basis vectors at that iteration;
performing hyperparameter optimization;
controlling the basis vector selection step and hyperparameter optimization step such that the steps are alternately performed until a specified termination criteria is met; and
storing the selected basis vectors and optimized hyperparameters in at least one tangible computer readable medium organized in a manner to be usable as the model of the sparse GP classifier.

2. The method of claim 1, wherein:
the margin-based method is such that basis vector selection is based on the ratio of absolute value of posterior mean plus bias and a function of posterior variance.

3. The method of claim 1, wherein:
the basis vector selection performing step is carried out without creating a working set of basis vectors from which to select a basis vector to add to the basis vector set.

4. A method of generating a model of a sparse GP classifier, the classifier usable to classify examples as being either in or not in a particular category, comprising:
performing basis vector selection and adding a thus-selected basis vector to a basis vector set, including an adaptive-sampling technique that accounts for probability characteristics associated with the candidate basis vectors;
performing hyperparameter optimization;
controlling the basis vector selection step and hyperparameter optimization step such that the steps are alternately performed until a specified termination criteria is met; and
storing the selected basis vectors and optimized hyperparameters in at least one tangible computer readable medium organized in a manner to be usable as the model of the sparse GP classifier.

5. The method of claim 4, wherein:
accounting for probability characteristics associated with the candidate basis vectors includes favoring a candidate basis vector, for selection, associated with a high probability characteristic over a candidate basis vector associated with a lower probability characteristic.

6. The method of claim 4, wherein:
accounting for probability characteristics associated with the candidate basis vectors includes determining candidate basis vectors that are more likely to correspond to wrongly classified examples or to examples correctly classified with insufficient confidence.

7. A method of generating a model of a sparse GP classifier, the classifier usable to classify examples as being either in or not in a particular category, comprising:
performing basis vector selection, including considering a weighted negative-log predictive (NLP) loss measure for each example;
performing hyperparameter optimization including considering a weighted negative-log predictive (NLP) loss measure for each example;
controlling the basis vector selection step and hyperparameter optimization step such that the steps are alternately performed until a specified termination criteria is met; and
storing the selected basis vectors and optimized hyperparameters in at least one tangible computer readable medium organized in a manner to be usable as the model of the sparse GP classifier.

8. The method of claim 7, wherein:
the weighted NLP loss measure is weighted using weights, for each example, that is a function of a probability score or degree of importance for that example.

9. A computer program product comprising at least one tangible computer-readable medium having computer program instructions tangibly embodied thereon, the computer program instructions to configure at least one computing device to generate a model of a sparse GP classifier, the classifier usable to classify examples as being either in or not in a particular category, including to:
perform basis vector selection and adding a thus-selected basis vector to a basis vector set, including to perform a margin-based method that accounts for predictive mean and variance associated with all the candidate basis vectors at that iteration;
perform hyperparameter optimization;
control the basis vector selection and hyperparameter optimization such that the basis vector selection and hyperparameter optimization are alternately performed until a specified termination criteria is met; and
store the selected basis vectors and optimized hyperparameters in at least one tangible computer readable medium organized in a manner to be usable as the model of the sparse GP classifier.

10. The computer program product of claim 9, wherein:
the margin-based method is such that basis vector selection is based on the ratio of absolute value of posterior mean plus bias and a function of posterior variance.

11. The method computer program product of claim 9, wherein:
the basis vector selection is configured to be carried out without creating a working set of basis vectors from which to select a basis vector to add to the basis vector set.

12. A computer program product comprising at least one tangible computer-readable medium having computer program instructions tangibly embodied thereon, the computer program instructions to configure at least one computing device to generate a model of a sparse GP classifier, the classifier usable to classify examples as being either in or not in a particular category, including to:
perform basis vector selection and add a thus-selected basis vector to a basis vector set, including an adaptive-sampling technique that accounts for probability characteristics associated with the candidate basis vectors;
perform hyperparameter optimization;
control the basis vector selection step and hyperparameter optimization such that the basis vector selection step and hyperparameter optimization are alternately performed until a specified termination criteria is met; and
store the selected basis vectors and optimized hyperparameters in at least one tangible computer readable medium organized in a manner to be usable as the model of the sparse GP classifier.

13. The computer program product of claim 12, wherein:
accounting for probability characteristics associated with the candidate basis vectors includes favoring a candidate basis vector, for selection, associated with a high probability characteristic over a candidate basis vector associated with a lower probability characteristic.

14. The computer program product of claim 12, wherein:
being configured to account for probability characteristics associated with the candidate basis vectors includes being configured to determine candidate basis vectors that are more likely to correspond to wrongly classified examples or to examples correctly classified with insufficient confidence.

15. A computer program product comprising at least one tangible computer-readable medium having computer program instructions tangibly embodied thereon, the computer program instructions to configure at least one computing device to generate a model of a sparse GP classifier, the classifier usable to classify examples as being either in or not in a particular category, including to:
perform basis vector selection, including considering a weighted negative-log predictive (NLP) loss measure for each example;
perform hyperparameter optimization including to consider a weighted negative-log predictive (NLP) loss measure for each example;
control the basis vector selection and hyperparameter optimization step that the basis vector selection and hyperparameter optimization are alternately performed until a specified termination criteria is met; and
store the selected basis vectors and optimized hyperparameters in at least one tangible computer readable medium organized in a manner to be usable as the model of the sparse GP classifier.

16. The method computer program product of claim 15, wherein:
the weighted NLP loss measure is weighted using weights, for each example, that is a function of a probability score or degree of importance for that example.

17. A computer system comprising at least one computing device configured to generate a model of a sparse GP classifier, the classifier usable to classify examples as being either in or not in a particular category, including to:
perform basis vector selection and adding a thus-selected basis vector to a basis vector set, including to perform a margin-based method that accounts for predictive mean and variance associated with all the candidate basis vectors at that iteration;
perform hyperparameter optimization;
control the basis vector selection and hyperparameter optimization such that the basis vector selection and hyperparameter optimization are alternately performed until a specified termination criteria is met; and
store the selected basis vectors and optimized hyperparameters in at least one tangible computer readable medium organized in a manner to be usable as the model of the sparse GP classifier.

18. A computer system comprising at least one computing device configured to generate a model of a sparse GP classifier, the classifier usable to classify examples as being either in or not in a particular category, including to:
perform basis vector selection and add a thus-selected basis vector to a basis vector set, including an adaptive-sampling technique that accounts for probability characteristics associated with the candidate basis vectors;
perform hyperparameter optimization;
control the basis vector selection step and hyperparameter optimization such that the basis vector selection step and hyperparameter optimization are alternately performed until a specified termination criteria is met; and
store the selected basis vectors and optimized hyperparameters in at least one tangible computer readable medium organized in a manner to be usable as the model of the sparse GP classifier.

19. A computer system comprising at least one computing device configured to generate a model of a sparse GP classifier, the classifier usable to classify examples as being either in or not in a particular category, including to:
perform basis vector selection, including considering a weighted negative-log predictive (NLP) loss measure for each example;
perform hyperparameter optimization including to consider a weighted negative-log predictive (NLP) loss measure for each example;
control the basis vector selection and hyperparameter optimization step that the basis vector selection and hyperparameter optimization are alternately performed until a specified termination criteria is met; and
store the selected basis vectors and optimized hyperparameters in at least one tangible computer readable medium organized in a manner to be usable as the model of the sparse GP classifier.
